(19) United States
(12) Patent Application Publication
(10) Pub. No.: US 2017/0177205 A1
(43) Pub. Date: Jun. 22, 2017

(54) INPUT METHOD FOR RECOGNIZING USER INPUT ACCORDING TO VECTOR COMBINATION DERIVED FROM SINGLE-STROKE INPUT AND ASSOCIATED NON-TRANSITORY MACHINE READABLE MEDIUM

(71) Applicant: MEDIATEK INC., Hsin-Chu (TW)

(72) Inventor: Yi-Ping Chiu, Kaohsiung City (TW)

(21) Appl. No.: 14/977,651

(22) Filed: Dec. 22, 2015

(51) Int. Cl. G06F 3/0488; G06F 3/0346; G06F 1/16; G06F 3/01

(52) U.S. Cl. CPC G06F 3/04883; G06F 3/017; G06F 3/0346; G06F 1/163

(57) ABSTRACT

An input method includes following steps: recording a single-stroke input, converting the recorded single-stroke input into a vector combination defined by one or more pre-defined vectors, and performing user input recognition according to the vector combination. The vector based recognition scheme using certain distinguishable vectors may offer a higher recognition rate and/or a lower misjudgment rate. Moreover, since one user input may be immediately recognized at the end of one single-stroke input, the response time can be reduced to enhance the user experience.

### BACKGROUND

The present invention relates to a user input recognition technique, and more particularly, to an input method for recognizing a user input according to a vector combination derived from a single-stroke input and an associated non-transitory machine readable medium.

A conventional portable device may have an on-screen touch keyboard used for acting as a user input interface. However, when the conventional portable device is equipped with a small-sized touch screen, it is not convenient for the user to operate the on-screen touch keyboard displayed on the small-sized touch screen. As a result, using the on-screen touch keyboard may lead to a slow input speed. One solution may use an external hardware keyboard. However, it not convenient for the user to carry, install and use the external hardware keyboard due to its large size and heavy weight. Another solution may use a voice recognition mechanism. However, the recognition rate of the voice input may be low.

Thus, there is a need for an innovative input method that is easy to use and can offer a high input speed, a high recognition rate and/or a low misjudgment rate.

### SUMMARY

One of the objectives of the claimed invention is to provide an input method for recognizing a user input according to a vector combination derived from a single-stroke input and an associated non-transitory machine readable medium.

According to a first aspect of the present invention, an exemplary input method is disclosed. The exemplary input method includes: recording a single-stroke input; converting the recorded single-stroke input into a vector combination defined by one or more pre-defined vectors; and performing user input recognition according to the vector combination.

According to a second aspect of the present invention, an exemplary non-transitory machine readable medium is disclosed. The exemplary non-transitory machine readable medium stores a program code which, when executed by a processor, causes the processor to perform following steps: recording a single-stroke input; converting the recorded single-stroke input into a vector combination defined by one or more pre-defined vectors; and performing user input recognition according to the vector combination.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device according to an embodiment of the present invention.

FIG. 2 is a flowchart illustrating an input method according to an embodiment of the present invention.

FIG. 3 is a diagram illustrating mapping between letters of English alphabet and associated vector combinations according to an embodiment of the present invention.

FIG. 4 is a diagram illustrating occurrence probabilities of letters of English alphabet according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

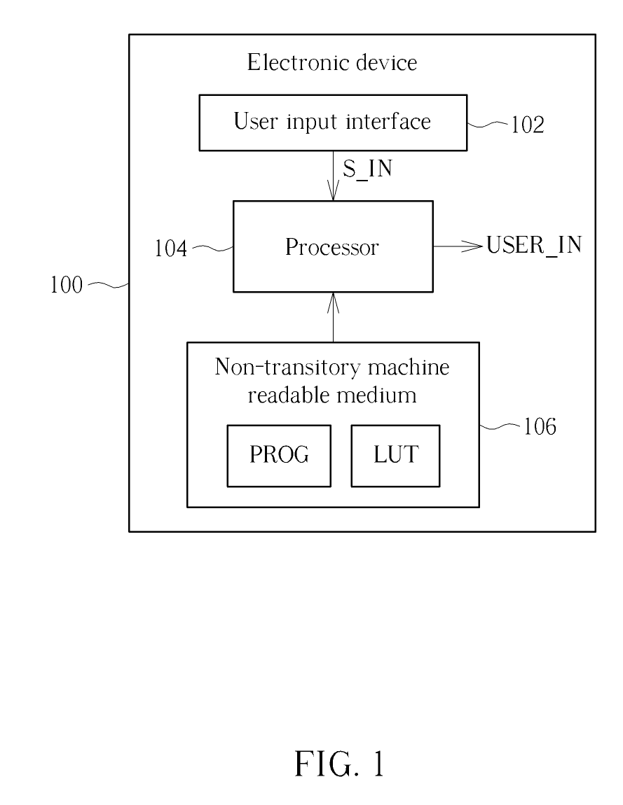

FIG. 1 is a diagram illustrating an electronic device according to an embodiment of the present invention. By way of example, but not limitation, the electronic device 100 may be a portable device with/without a touch screen. In one exemplary embodiment, the electronic device 100 may be one of wearable devices, including a watch, a ring, an armband, etc. As shown in FIG. 1, the electronic device 100 may include a user input interface 102, a processor 104, and a non-transitory machine readable medium 106. It should be noted that only the components pertinent to the present invention are shown in FIG. 1. In practice, the electronic device 100 may include additional components to achieve other functions.

The user input interface 102 may be any device capable of receiving a single-stroke input S_IN made by a user. For example, the user input interface 102 may be a touch screen, such that the single-stroke input S_IN may be generated by user's finger moving on/above the touch screen. When the proposed input method may be operative, the whole area of the touch screen may be used as a user interface for generating the single-stroke input S_IN. For another example, the user input interface 102 may be a joystick or a directional pad, such that the single-stroke input S_IN may be generated by controlling movement of the joystick/directional pad. For another example, the user input interface 102 may be a motion sensor (e.g., a Gyro sensor or an accelerometer), such that the single-stroke input S_IN may be generated by controlling movement of the electronic device 100. For another example, the user input interface 102 may be an eyeball sensor, such that the single-stroke input S_IN may be generated by tracking movement of user's eyeball. Since the user input interface 102 may not be limited to the touch screen only, the proposed input method may support more input options compared to the conventional design. However, these are for illustrative purposes only, and are not meant to be limitations of the present invention.

The non-transitory machine readable medium 106 may be used to store a program code PROG. For example, the program code PROG may be part of an operating system (OS) of the electronic device 100. For another example, the program code PROG may be an application of the electronic device 100. When executed by the processor 104, the program code PROG may instruct the processor 104 to perform the proposed input method to perform user input recognition. The non-transitory machine readable medium 106 maybe any storage device capable of storing the program code PROG. For example, the non-transitory machine readable medium 106 may be a non-volatile memory or a volatile memory.

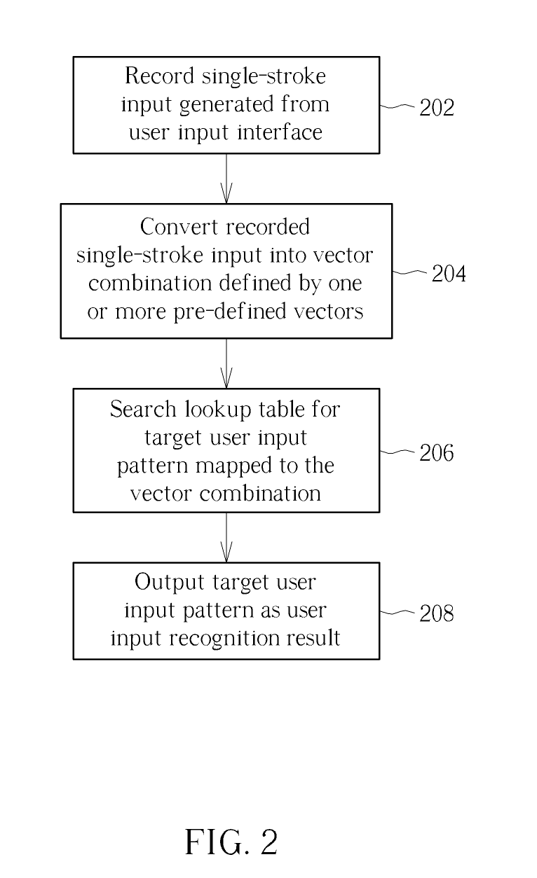

FIG. 2 is a flowchart illustrating an input method according to an embodiment of the present invention. The steps may not be required to be executed in the exact order shown in FIG. 2. In addition, certain steps may be added to or removed from the flow shown in FIG. 2, depending upon actual design considerations. In this embodiment, the proposed input method may be performed by the program code PROG running on the processor 104, and may be briefly summarized as below.

Step 202: Record a single-stroke input S_IN generated from the user input interface 102.

Step 204: Convert the recorded single-stroke input S_IN into a vector combination defined by one or more pre-defined vectors.

Step 206: Search a lookup table LUT for a target user input pattern mapped to the vector combination obtained in step 204, wherein the lookup table LUT records a plurality of candidate user input patterns mapped to a plurality of candidate vector combinations, respectively.

Step 208: Output the target user input pattern obtained in step 206 as a user input recognition result USER_IN corresponding to the single-stroke input S_IN.

In step 202, the single-stroke input S_IN may mean a one-time input continuously generated from a start point to an end point. The conditions for triggering a start point and an end point of the same single-stroke input S_IN may depend on the actual implementation of the user input interface 102. Considering a case where the user input interface 102 may be implemented using a touch screen, a condition for triggering a start point of one single-stroke input S_IN may be true when the touch screen has a touch-down event due to user's finger approaching the touch screen or having a physical contact with the touch screen, and a condition for triggering an end point of one single-stroke input S_IN may be true when the touch screen has a touch-up event due to user's finger leaving the touch screen or having no physical contact with the touch screen. However, these are for illustrative purposes only, and are not meant to be a limitation of the present invention. When the user input interface 102 may be implemented using a different interface design such as a joystick, a directional pad, a motion sensor or an eyeball sensor, the conditions for triggering a start point and an end point of one single-stroke input S_IN may be adjusted correspondingly to meet the inherent characteristics of the employed interface design.

In step 204, the recorded single-stroke input S_IN may be converted into a vector combination defined by one or more pre-defined vectors. That is, a graphic representation of the recorded single-stroke input S_IN may not be used by the following user input recognition process. Instead, the vector combination derived from the recorded single-stroke input S_IN may be used by the following user input recognition process. Compared to the graphic based recognition scheme, the proposed vector based recognition scheme using certain distinguishable vectors may offer a higher recognition rate and/or a lower misjudgment rate.

In a first exemplary design, each pre-defined vector may be one direction. For example, all of the selectable pre-defined vectors may be different directions, such as 8 directions “←”, “↑”, “→”, “↓”, “ [symbol] ”, “ [symbol] ”, “ [symbol] ”, “ [symbol] ”. Hence, a trajectory of the recorded single-stroke input S_IN may be analyzed to determine a vector combination defined by pre-defined vector (s) each being one of the selectable directions.

In a second exemplary design, each pre-defined vector may be one length. For example, all of the selectable pre-defined vectors may be different lengths in the same direction or different directions. Hence, the recorded single-stroke input S_IN may be analyzed to determine a vector combination defined by pre-defined vector(s) each being one of the selectable lengths.

In a third exemplary design, each pre-defined vector may be one color. For example, all of the selectable pre-defined vectors may be different colors. Hence, the recorded single-stroke input S_IN may be analyzed to determine a vector combination defined by pre-defined vector(s) each being one of the selectable colors.

In a fourth exemplary design, each pre-defined vector may be one pressure such as the contact pressure of user's finger on the touch screen. For example, all of the selectable pre-defined vectors may be different pressures. Hence, the recorded single-stroke input S_IN may be analyzed to determine a vector combination defined by pre-defined vector(s) each being one of the selectable pressures.

In a fifth exemplary design, each pre-defined vector may be one temperature such as the temperature of a stylus on/above the touch screen. For example, all of the selectable pre-defined vectors may be different temperatures. Hence, the recorded single-stroke input S_IN may be analyzed to determine a vector combination defined by pre-defined vector (s) each being one of the selectable temperatures.

In a sixth exemplary design, each pre-defined vector may be one size such as the size of a graphic area. For example, all of the selectable pre-defined vectors may be different sizes. Hence, the recorded single-stroke input S_IN may be analyzed to determine a vector combination defined by pre-defined vector(s) each being one of the selectable sizes.

To put it simply, the present invention has no limitations on the format of the pre-defined vectors. Hence, dimensions, types and/or numbers of the pre-defined vectors may be adjusted, depending upon actual design considerations.

After the vector combination associated with the single-stroke input S_IN may be decided, user input recognition may be performed according to the vector combination (steps 206 and 208). In step 206, the lookup table LUT may be checked to search for a target user input pattern mapped to the vector combination obtained in step 204. In step 208, the target user input pattern obtained in step 206 may be output as the user input recognition result USER_IN corresponding to the single-stroke input S_IN. Since one user input may be immediately recognized at the end of one single-stroke input, the response time can be reduced to enhance the user experience. For example, a conventional multi-stroke input method (e.g., typical handwriting input method) may need to judge if a user finishes inputting all strokes associated with a user input pattern, and may not start the recognition of the user input pattern until all strokes associated with the user input pattern are already input. Hence, compared to the conventional multi-stroke input method, the proposed vector based single-stroke input method may have a faster input speed.

The lookup table LUT may be stored in any storage device accessible to the processor 104. In this embodiment, the lookup table LUT may be stored in the non-transitory machine readable medium 106. The lookup table LUT may be regarded as a mapping database, and therefore may record a plurality of candidate user input patterns mapped to a plurality of candidate vector combinations, respectively. In this embodiment, there may be one-to-one mapping between candidate user input patterns and candidate vector combinations. That is, the same candidate vector combination may not be mapped to different candidate user input patterns. Hence, with a proper design of the lookup table LUT, a single target user input pattern may be automatically determined for each single-stroke input S_IN without user intervention. That is, the user does not need to manually select a target user input pattern from multiple user input patterns mapped to the same vector combination.

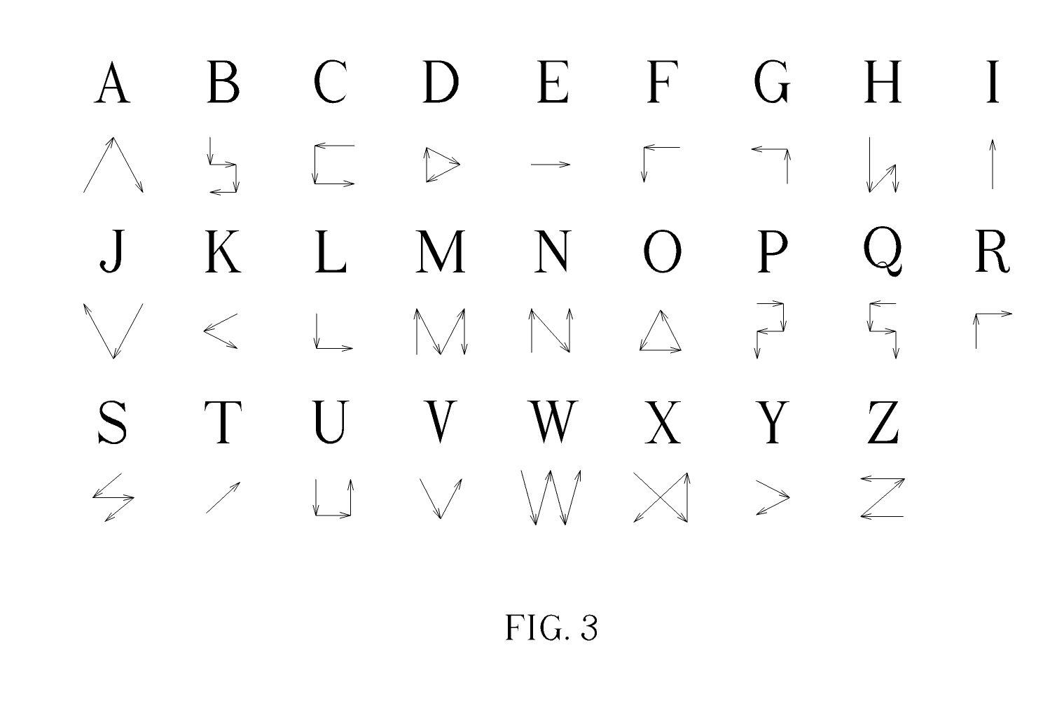

For example, the candidate user input patterns may include characters such as 26 letters A-Z of the English alphabet. Hence, each of the letters A-Z may be assigned with one dedicated vector combination only. FIG. 3 is a diagram illustrating mapping between letters A-Z and associated vector combinations according to an embodiment of the present invention. In this example, each pre-defined vector may be one direction. Hence, the mapping between letters of English alphabet and associated vector combinations may be recorded in the following table. It should be noted that this is for illustrative purposes only, and is not meant to be a limitation of the present invention.

| | |
|---|---|
| Letter | Vector combination |

| | | | | |
|---|---|---|---|---|
| A | [symbol] | [symbol] | | |
| B | ↓ | → | ↓ | ← |
| C | ← | ↓ | → | |
| D | ↑ | [symbol] | [symbol] | |
| E | → | | | |
| F | ← | ↓ | | |
| G | ↑ | ← | | |
| H | ↓ | [symbol] | ↓ | |
| I | ↑ | | | |
| J | [symbol] | [symbol] | | |
| K | [symbol] | [symbol] | | |
| L | ↓ | → | | |
| M | ↑ | [symbol] | [symbol] | ↓ |
| N | ↑ | [symbol] | ↑ | |
| O | [symbol] | → | [symbol] | |
| P | → | ↓ | ← | ↓ |
| Q | ← | ↓ | → | ↓ |
| R | ↑ | → | | |
| S | [symbol] | → | [symbol] | |
| T | [symbol] | | | |
| U | ↓ | → | ↑ | |
| V | [symbol] | [symbol] | | |
| W | [symbol] | [symbol] | [symbol] | [symbol] |
| X | [symbol] | ↑ | [symbol] | |
| Y | [symbol] | [symbol] | | |
| Z | ← | [symbol] | ← | |

In this example, a single letter may be assigned with a dedicated vector combination. Alternatively, a series of letters may be assigned with one dedicated vector combination.

Since pre-defined vector (s) of a vector combination mapped to each letter may be similar to the handwriting of the letter, it may be easy for a user to memorize the one-to-one mapping between the letters A-Z and the associated vector combinations.

With a proper design of the look-up table LUT, the candidate user input patterns may include characters of Non-English alphabet, such as Chinese characters and/or Japanese characters. Hence, the proposed input method may allow the user to input Non-English characters. This also falls within the scope of the present invention.

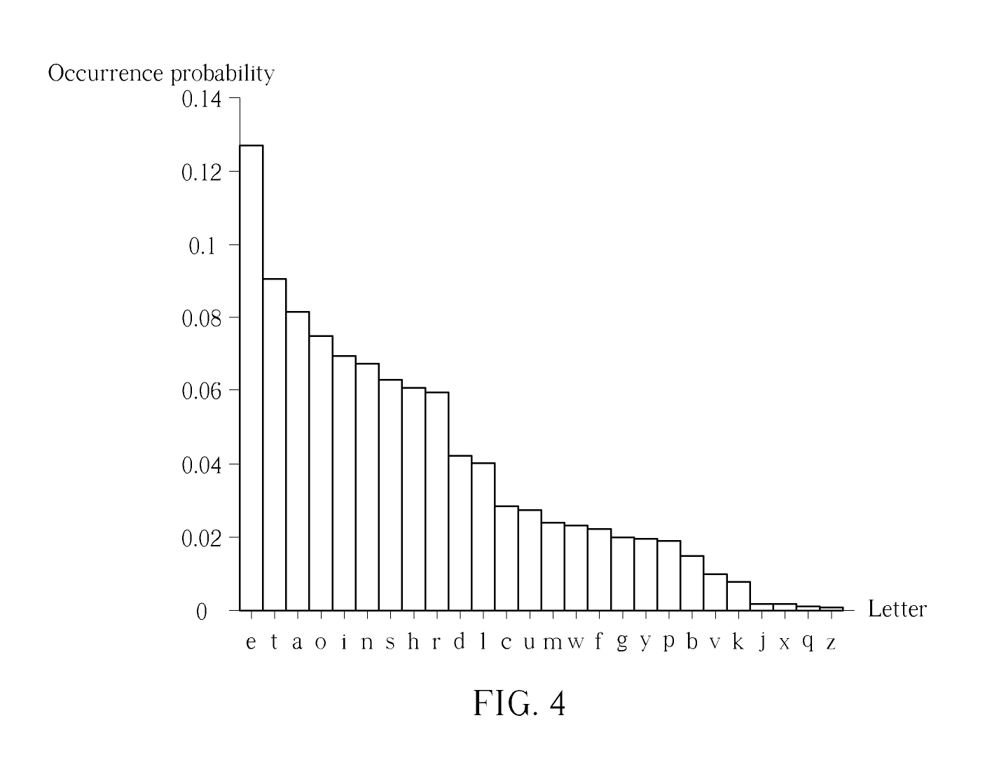

In one exemplary design, a first candidate user input pattern with a first occurrence probability may be mapped to a first candidate vector combination defined by a first number of pre-defined vectors, and a second candidate user input pattern with a second occurrence probability lower than the first occurrence probability may be mapped to a second candidate vector combination defined by a second number of pre-defined vectors, where the first number may be smaller than the second number. Hence, a candidate user input pattern with a highest occurrence probability among the candidate user input patterns may be mapped to a candidate vector combination defined by a smallest number of pre-defined vectors (e.g., only a single pre-defined vector). For example, the candidate user input patterns may include characters such as 26 letters A-Z of the English alphabet. Since there may be one-to-one mapping between candidate user input patterns and candidate vector combinations, a more frequently used letter may be assigned with a smaller number of pre-defined vectors (e.g., directions), and a less frequently used letter may be assigned with a larger number of pre-defined vectors (e.g., directions). FIG. 4 is a diagram illustrating occurrence probabilities of 26 letters A-Z of the English alphabet according to an embodiment of the present invention. As can be known from the statistics of frequently used letters of the English alphabet, the most frequently used letter may be “E”, and the second most frequently used letter may be “T”. Hence, as shown in FIG. 3, the most frequently used letter “E” may be assigned with a vector combination having only a single pre-defined vector (e.g., direction “→”), and the second most frequently used letter “T” may be assigned with a vector combination having only a single pre-defined vector (e.g., direction “ [symbol] ”). Since the most frequently used letter “E” and the second most frequently used letter “T” can be input using the smaller number of pre-defined vectors, the input speed as well as the recognition speed for these letters “E” and “T” can be improved greatly.

In addition to the letters A-Z of the English alphabet, the characters included in the candidate user input patterns may further include numbers 0-9. For example, the mapping between numbers and associated vector combinations may be recorded in the following table. It should be noted that this is for illustrative purposes only, and is not meant to be a limitation of the present invention.

| | |
|---|---|
| Number | Vector combination |

| | | | | | |
|---|---|---|---|---|---|
| 1 | ↓ | | | | |
| 2 | → | [symbol] | → | | |
| 3 | [symbol] | [symbol] | [symbol] | [symbol] | |
| 4 | ↑ | [symbol] | → | | |
| 5 | ← | ↓ | → | ↓ | ← |
| 6 | ↓ | [symbol] | ← | | |
| 7 | ↑ | → | ↓ | | |
| 8 | ← | [symbol] | ← | [symbol] | |
| 9 | [symbol] | → | [symbol] | ↓ | |
| 0 | [symbol] | → | [symbol] | | |

In this example, a single number may be assigned with a dedicated vector combination. Alternatively, a series of numbers may be assigned with one dedicated vector combination.

In addition to letters A-Z and/or numbers 0-9 of the English alphabet, the characters included in the candidate user input patterns may further include symbols (e.g., ?, ˜, !, @, #, $, %, \hat{0}, &, +, −, *, /, etc.). For example, the mapping between symbols and associated vector combinations maybe recorded in the following table. It should be noted that this is for illustrative purposes only, and is not meant to be a limitation of the present invention.

| | |
|---|---|
| Symbol | Vector combination |

| | | | | |
|---|---|---|---|---|
| * | [symbol] | ↑ | [symbol] | |
| + | → | [symbol] | ↓ | |
| − | → | ↑ | → | |
| ′ | → | ↑ | | |
| ″ | → | ↑ | → | ↑ |
| . | [symbol] | | | |
| , | [symbol] | | | |
| ; | → | ↓ | ← | |
| ( | [symbol] | [symbol] | | |
| ) | [symbol] | [symbol] | | |
| [ | ← | ↑ | → | |
| ] | → | ↑ | ← | |
| { | [symbol] | [symbol] | [symbol] | [symbol] |
| } | [symbol] | [symbol] | [symbol] | [symbol] |
| ? | [symbol] | [symbol] | [symbol] | |
| ~ | [symbol] | [symbol] | [symbol] | |
| ! | ↓ | [symbol] | → | [symbol] |
| @ | [symbol] | [symbol] | [symbol] | [symbol] |
| # | ↓ | [symbol] | ↓ | |
| $ | [symbol] | ← | [symbol] | |
| % | ↑ | [symbol] | ↑ | |
| \hat{ } | [symbol] | [symbol] | | |
| & | [symbol] | → | [symbol] | → |

In this example, a single symbol may be assigned with a dedicated vector combination. Alternatively, a series of symbols may be assigned with one dedicated vector combination.

Further, the candidate user input patterns may include text editing functions (e.g., Back, Enter, Space, Esc, Insert, Delete, Home, End, Page Up, Page Down, etc.). For example, the mapping between text editing functions and associated vector combinations may be recorded in the following table. It should be noted that this is for illustrative purposes only, and is not meant to be a limitation of the present invention.

| Text editing | | | | | |
|---|---|---|---|---|---|
| function | Vector combination | | | | |
| [Back] | ← | | | | |
| [Enter] | ↓ | ← | | | |
| [Space] | → | ↓ | | | |
| [Tab] | → | ↓ | → | ↓ | |
| [Esc] | ↑ | ← | ↓ | | |
| [Ins] | ↑ | ↓ | | | |
| [Del | ← | → | | | |
| [↓] | ↓↓ | | | | (two-finger) |
| [↑] | ↑↑ | | | | (two-finger) |
| [←] | ←← | | | | (two-finger) |
| [→] | →→ | | | | (two-finger) |
| [Home] | [symbol] | | | | (two-finger) |
| [End] | [symbol] | | | | (two-finger) |
| [PgUp] | [symbol] | | | | (two-finger) |
| [PgDn] | [symbol] | | | | (two-finger) |
| [Shift] | [symbol] | | | | |
| [Caps Lock] | [symbol] | [symbol] | | | |
| [Capitalization] | [symbol] | [Lowercase] | | | |

In this example, a single text editing function may be assigned with a dedicated vector combination. Alternatively, a series of text editing functions may be assigned with one dedicated vector combination.

As mentioned above, the pre-defined vectors may be lengths, colors, pressures, temperatures and/or sizes. The vector combinations listed in above tables may be replaced by combinations of lengths, combinations of colors, combinations of pressures, combinations of temperatures, and/or combinations of sizes. These alternative designs all fall within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An input method comprising:
recording a single-stroke input;
converting the recorded single-stroke input into a vector combination defined by one or more pre-defined vectors; and
performing user input recognition according to the vector combination.

2. The input method of claim 1, wherein performing the user input recognition comprises:
searching a lookup table for a target user input pattern mapped to the vector combination, wherein the lookup table records a plurality of candidate user input patterns mapped to a plurality of candidate vector combinations, respectively.

3. The input method of claim 2, wherein a same candidate vector combination is not mapped to different candidate user input patterns.

4. The input method of claim 2, wherein a candidate user input pattern with a highest occurrence probability is mapped to a candidate vector combination defined by a smallest number of pre-defined vectors.

5. The input method of claim 2, wherein the candidate user input patterns comprise characters.

6. The input method of claim 2, wherein the candidate user input patterns comprise text editing functions.

7. The input method of claim 1, wherein recording the single-stroke input comprises:
recording the single-stroke input generated from a touch screen, a joystick, a directional pad, a motion sensor or an eyeball sensor.

8. The input method of claim 1, wherein converting the recorded single-stroke input comprises:
analyzing a trajectory of the recorded single-stroke input.

9. The input method of claim 1, wherein the input method is employed by a wearable device.

10. The input method of claim 1, wherein the one or more pre-defined vectors comprise at least one of direction, length, color, pressure, temperature and size.

11. A non-transitory machine readable medium storing a program code which, when executed by a processor, causes the processor to perform following steps:
recording a single-stroke input;
converting the recorded single-stroke input into a vector combination defined by one or more pre-defined vectors; and
performing user input recognition according to the vector combination.

12. The non-transitory machine readable medium of claim 11, wherein performing the user input recognition comprises:
searching a lookup table for a target user input pattern mapped to the vector combination, wherein the lookup table records a plurality of candidate user input patterns mapped to a plurality of candidate vector combinations, respectively.

13. The non-transitory machine readable medium of claim 12, wherein a same candidate vector combination is not mapped to different candidate user input patterns.

14. The non-transitory machine readable medium of claim 12, wherein a candidate user input pattern with a highest occurrence probability is mapped to a candidate vector combination defined by a smallest number of pre-defined vectors.

15. The non-transitory machine readable medium of claim 12, wherein the candidate user input patterns comprise characters.

16. The non-transitory machine readable medium of claim 12, wherein the candidate user input patterns comprises text editing functions.

17. The non-transitory machine readable medium of claim 12, wherein recording the single-stroke input comprises:
recording the single-stroke input generated from a touch screen, a joystick, a directional pad, a motion sensor or an eyeball sensor.

18. The non-transitory machine readable medium of claim 11, wherein converting the recorded single-stroke input comprises:
analyzing a trajectory of the recorded single-stroke input.

19. The non-transitory machine readable medium of claim 11, wherein the processor is part of a wearable device.

20. The non-transitory machine readable medium of claim 11, wherein the one or more pre-defined vectors comprise at least one of direction, length, color, pressure, temperature and size.
